(19) United States
(12) Patent Application Publication
(10) Pub. No.: US 2023/0114598 A1
(43) Pub. Date: Apr. 13, 2023

(54) SECURE MODEL GENERATION AND TESTING TO PROTECT PRIVACY OF TRAINING DATA AND CONFIDENTIALITY OF THE MODEL

(71) Applicant: Intel Corporation, Santa Clara, CA (US)

(72) Inventor: Matthias Schunter, Seeheim-Jugenheim (DE)

(21) Appl. No.: 18/063,948

(22) Filed: Dec. 9, 2022

(51) Int. Cl. G06F 21/53

(52) U.S. Cl. CPC G06F 21/53; G06F 2221/033

(57) ABSTRACT

Systems, apparatuses, and methods include technology that stores, with a server, a plurality of machine learning models in a first trusted execution environment. The plurality of machine learning models is associated with personal identifiable information. The technology generates, in the first trusted execution environment, a derivative machine learning model based on the plurality of machine learning models, and determines, with the server, that the derivative machine learning model will be transmitted to an approval node over a secure channel.

### TECHNICAL FIELD

Examples generally relate to a privacy enhanced training scheme for machine learning that ensures the privacy of training data.

BACKGROUND

Machine Learning (ML) models are trained on various types of training data. For example, ML models may be trained on sensitive and personal real-world data such as personally identifiable information (PII). Large scale collection of sensitive and personal data (e.g., PII) entails risks. The consequences of mishandling sensitive data may be devastating from a privacy, business and economic perspective. In some cases, the PII may be extrapolated from the ML models leading to the negative consequences mentioned above.

### BRIEF DESCRIPTION OF THE DRAWINGS

The various advantages of the embodiments will become apparent to one skilled in the art by reading the following specification and appended claims, and by referencing the following drawings, in which:

FIG. 1 is an example of generating a ML model based on PII according to an embodiment;

FIG. 2 is a flowchart of an example of a method of a federated process of generating a ML model based on PII according to an embodiment;

FIG. 3 is a flowchart of an example of a method of generating a privacy secured ML model from the perspective of an edge node according to an embodiment;

FIG. 4 is a flowchart of an example of a method of generating a derivative machine learning model from the perspective of a server node according to an embodiment;

FIG. 5 is a flowchart of an example of a method of determining whether to approve a derivative machine learning model from the perspective of an approval node according to an embodiment;

FIG. 6 is a flowchart of an example of a method of determining whether to approve a derivative machine learning model from the perspective of a release node according to an embodiment;

FIG. 7 is a diagram of an example of a model computing system according to an embodiment;

FIG. 8 is an illustration of an example of a semiconductor apparatus according to an embodiment;

FIG. 9 is a block diagram of an example of a processor according to an embodiment; and

FIG. 10 is a block diagram of an example of a multi-processor based computing system according to an embodiment.

### DESCRIPTION OF EMBODIMENTS

Examples as described herein provide an anonymized ML model that is generated based on PII. The ML model is applicable to a wide variety of applications, such as medical screening, fraud detections, autonomous driving, etc. The ML model is securely generated, transferred and analyzed in a hardware protected space to reduce the probability of the PII being compromised. As a consequence, unlike prior schemes, the resulting model can be freely distributed.

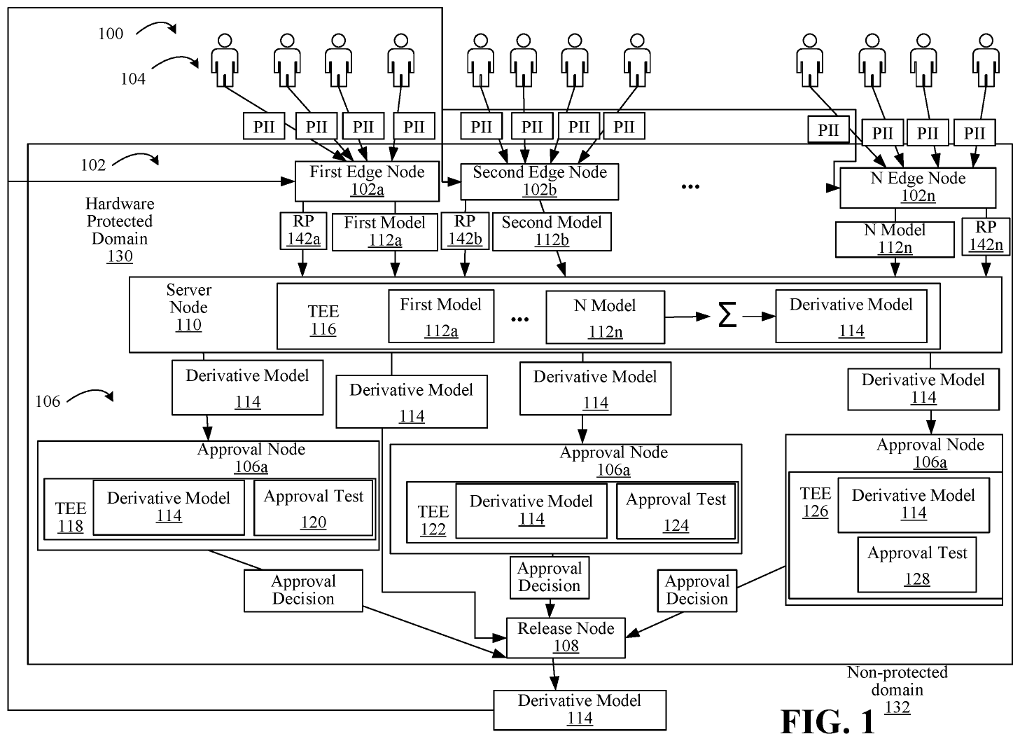

Turning to FIG. 1, a federated ML training process 100 based on PII is illustrated. The PII may be generated by a plurality of users 104. As will be described below, the federated ML training process 100 incorporates PII during training. The federated ML training process 100 provides a hardware protected domain 130 that securely stores, processes, and modifies PII related ML models to reduce the probability of the PII being identified by third-parties (e.g., nefarious actors). Furthermore, the federated ML training process 100 employs a distributed and multi-party analysis to verify and approve the release of any generated ML model.

Furthermore, examples enhance security by leveraging secure hardware components to perform several features in a distributed environment. For example, any ML models based on the PII are either maintained by the owners of the PII, and/or in a hardware protected domain 130 that includes secure connections and trusted execution environments (TEEs) 116, 118, 122, 126. Notably the hardware protected domain 130 protects the ML models within various hardware architectures to reduce the probability of attacks on the ML models. The ML models may only be released when it has been verified by multiple, distributed parties that PII is unable to be obtained from the ML models.

Federated training is a technique that trains a joint ML model across a plurality of edge nodes 102 (e.g., multiple decentralized edge nodes). The server node 110 (e.g., a centralized server) chooses the ML model and transmits the ML model to the plurality of edge nodes 102 after the ML model is approved for release by a release node and approval node. Each edge node of the plurality of edge nodes 102 trains a local copy of the ML model on PII owned by the edge node and sends updates to the server node 110. The server node 110 aggregates the updates from the plurality of edge nodes 102 into a derivative model 114 (e.g., a new global ML model). In such a fashion, the plurality of edge nodes 102 obtains an enhanced and robust shared ML model without sharing the data (e.g., PII) among the plurality of edge nodes 102 or server node 110.

The federated ML training process 100 gathers PII from a plurality of users 104. For example, the plurality of users 104 may be patients of a hospital whose details are tracked and gather during treatment and care. The details are stored as PII. The PII cannot be shared. For example, the second edge node 102b cannot share the PII received by the second edge node 102b with the server node 110 or any other of the plurality of edge nodes 102 unless it is through a hardware protected fashion.

The plurality of edge nodes 102 includes first edge node 102a-N edge node 102n. The first-N edge nodes 102a-102n may be associated with different networks. For example, the first-N edge nodes 102a-102n may each correspond to a different hospital. For example, the first edge node 102a may be owned by a first hospital, while the second edge node 102b may be owned by a second hospital different from the first hospital. Several patients may provide PII to the first hospital which in turn provides the PII to the first edge node 102a. Similarly, several patients may provide PII to the second hospital which in turn provides the PII to the second edge node 102b.

The federated ML training process 100 employs a federated training technique. The plurality of edge nodes 102 may generate first model 112a-N model 112n (e.g., ML models) based on the PII. While not illustrated, the first model 112a-N model 112n may be generated based on an initial ML model that is generated by the server node 110 and propagated to the plurality of edge nodes 102 by the release node 108. Each of the first-N edge nodes 102a-102n may train the initial ML model based on the PII received by the first-N edge nodes 102a-102n to generate the first model 112a-N model 112n. In some examples, the first-N edge nodes 102a-102n may generate the first model 112a-N model 112n without the initial ML model. The plurality of edge nodes 102 are part of the hardware protected domain 130 and thus are able to share the PII with other nodes of the hardware protected domain 130 since all elements in the hardware protected domain 130 are protected by hardware.

The first model 112a-N model 112n may be unique ML models. For example, the first edge node 102a may generate the first model 112a based on a unique set of PII that is provided to the first edge node 102a. Similarly, the second edge node 102b may generate the second model 112b based on a unique set of PII that is provided to the second edge node 102b and so forth. Thus, each of the plurality of edge nodes 102 may generate a different model based on unqiue PII.

Thus, the PII is used to train the first-N models 112a-112n. This training may implement additional privacy mechanisms such as Deep Learning with Differential Privacy (DP-SGD). The first-N models 112a-112n are candidate models that are at risk of being associated with PII training data. The plurality of edge nodes 102 submits the first-N models 102a-102n via secure channels into a TEE 116 provided by the server node 110.

Before submitting the first-N models 112a-112n to the server node 110, the edge nodes 102a-102n may verify the integrity of the TEE 116 and the provided security guarantees of the TEE 116 using attestation. Thus, prior to releasing any of the first-N model 112a-112n to the server node 110 that may contain PII and/or be used to extrapolate PII, the plurality of edge nodes 102 may verify that security agreements will be enforced.

The server node 110 is a centralized node that receives the first model 112a-N model 112n. The server node 110 provides a distribution and/or aggregation service within a TEE 116. For example, the TEE 116 may be a hardware portion of a processor of the server node 110. The TEE 116 may be a secure area of a main processor of the server node 110 and guarantees code and data loaded inside of the TEE 116 will be protected with respect to confidentiality and integrity (e.g., data integrity). Thus, the TEE 116 may provide security in a hardware protected environment.

The server node 110 collects the first-N model 112a-112n from plurality of edge nodes 102a-102n and compiles a candidate package for release. In this example, the server node 110 modifies the first-N model 112a-112n to generate a derivative model 114. The derivative model 114 may contain one or more models or a derivative of the first-N model 112a-112n. For example, the server node 110 may aggregate the first-N models 112a-112n to generate the derivative model 114.

Prior to forwarding the derivative model 114 to any party that did not provide the PII, generate the derivative model 114 and/or outside the hardware protected domain 130, examples may verify the integrity of the derivative model 114. In some examples, the plurality of edge nodes 102 may need to agree to releasing the derivate model 114 and thus generate release policies (RP) 142a-142n that must be met prior to releasing the derivative model 114 outside the hardware protected domain 130. The RP 142a-142n may be synchronized with each other, through direct communication between the plurality of edge nodes 102 or through the server node 110, such that the plurality of edge nodes 102 agree to a standard RP.

The server node 110 then provides the derivative model 114 to the plurality of approval nodes 106 and the release node 108 over secure connections. The plurality of approval nodes 106 store the derivative model 114 in TEEs 118, 122, 126 of processors. Although not illustrated, the release node 108 may also store the derivative model 114 in a TEE of a processor of the release node 108.

The approval nodes 106 provides an “approval service” within TEEs 118, 122, 126. The approval nodes 106 may be the plurality of edge nodes 102 or some other node that performs privacy audits. Prior to transmitting the derivative model 114, the server node 110 verifies the integrity and the provided security guarantees of the TEEs 118, 122, 126 using attestation. If one TEE of the TEEs 118, 122, 126 fails to attest and/or the integrity cannot be verified, the one TEE will be bypassed so that the server node 110 does not transmit the derivative model 114 to the one TEE.

The approval nodes 106 may evaluate whether the PII is retrievable and/or identifiable from the derivative model 114. Each respective approval node of the approval nodes 106 performs one or more approval tests 120, 124, 128 within the TEEs 118, 122, 126. If the derivative model 114 successfully passes the approval tests 120, 124, 128, the respective approval node submits an approval indication to the release node 108 over secure connections. Thus, each of the approval nodes 106a provides an approval decision to the release node 108. In some examples, the approval nodes 106 may ensure compliance with the RP 142a-142n (e.g., specific tests), and provide an approval indication if the RP 142a-142n is met.

The approval nodes 106 may execute privacy related analysis on the derivative model 114 to determine whether the derivative model 114 may be released to other parties, and eventually to outside the hardware protected domain 130. For example, as noted above, all participating nodes of the plurality of edge nodes 102 may agree on a RP, shows as RPs 142a-142-n, that must be satisfied before the derivative model 114 is released. In some examples, the plurality of edge nodes 102 are the approval nodes 106. Thus, in some examples the derivative model 114 may only be released once all contributing owners of the PII, that is the first edge node 102a-N edge node 102n which are the approval nodes 106, have validated the derivative model 114 and explicitly registered approval to release the derivative model 114. In this example, the RP is that all the approval nodes 106 vote that the derivative model 114 is to be released. The approval decisions may contain the votes. It is to be noted that if the plurality of edge nodes 102 are the approval nodes 106, the plurality of edge nodes 102 would be considered to be part of the hardware protected domain 130.

An exemplary approval test of the approval tests 120, 124, 128 includes membership inference tests to ensure that entities cannot determine the PII that was used to train the model. Since the plurality of edge nodes 102, approval nodes 106 and approval tests 120, 124, 128 are in the hardware protected domain 130, unlike in conventional implementations, the approval tests 120, 124, 128 may use the original PII accessible to the plurality of edge nodes 102. Thus the approval nodes 106 have access to the PII that was used to generate the first model 112a-N model 112n to execute the approval tests 120, 124, 128. In some examples, the plurality of edge nodes 102 may share (selected) PII with approval tests 120, 124, 128 since all elements are hardware protected. In some examples, the approval tests 120, 124, 128 may be shared with the plurality of edge nodes 102 which in turn execute the approval tests 120, 124, 128

In some examples the plurality of edge nodes 102 may be the approval nodes 106. For example, an attack model may be trained whose purpose is to distinguish the behavior of the derivative model 114 on the training inputs of the PII from behavior of the derivative model 114 on the inputs that the derivative model 114 did not encounter during training. That is, the membership inference problem is treated as a classification problem which exploits the observation that machine learning models often behave differently on data that the machine models were trained on versus the data that they observe for the first time. Overfitting may be a cause of such a differences. The objective of the attacker is to construct an attack model that may recognize such differences in a target model's behavior and use them to distinguish members from non-members of the target model's training dataset based solely on the target model's output.

An exemplary approval test of the approval tests 120, 124, 128 includes a model inversion test to validate that the derivative model 114 cannot be inverted. For example, under a model inversion attack, a data controller who does not initially have direct access to the PII, but is given access to another dataset and derivative model 114, is able to recover some of the variables in the PII, for those individuals in both the PII and another dataset. These variables connect to each other, such that the new personal dataset in question has all the variables of another dataset and some of PII.

Another model inversion test includes membership inference attacks that do not recover training data, but instead ascertain whether a given individual's data were in a training set or not. Under a membership inference attack, the holder of a dataset and derivative model 114 does not recover any of the columns in the PII, but may add an additional column to the dataset representing whether or not a member of the dataset was also part of the PII.

An exemplary approval test of the approval tests 120, 124, 128 includes complex tests for privacy audits such as a ML Privacy Meter. A ML Privacy Meter that quantifies the privacy risks to training data and is based on well-established algorithms to measure privacy risks of machine learning models through membership inference attacks. The approval tests 120, 124, 128 may include other tests that validate whether the PII is identifiable from the derivative model 114.

Notably, one or more of the exemplary tests may rely on PII that is usually only accessible to the plurality of edge nodes 102. Thus, the approval nodes 106 may collaborate with the plurality of edge nodes 102 that have access to the PII and are able to execute the above tests.

Therefore, the plurality of approval nodes 106 receive the derivative model 114 from the server node 110. The plurality of approval nodes 106 executes approval tests 120, 124, 128 to verify that the PII cannot be derived from the derivative model 114, generates approval decisions (e.g., votes for release or against release) based on the execution of the approval tests 120, 124, 128, and transmits the approval decisions to the release node 108.

The release node 108 identifies that the release policy is met based on the approval decisions. For example, the release node 108 may determine that the derivative model 114 is approved by the approval nodes 106 for transmission outside the hardware protected domain 130 based on the RP being met.

The release node 108 may determine whether the approval decisions meet one or more of a pre-determined condition or a predetermined policy, and determine whether to release the derivative model 114 based on whether the approval decisions meet the one or more of the pre-determined condition or the predetermined policy. For example, the pre-determined condition or the predetermined policy may be the RFPs 142a-142n.

That is, the release node 108 receives the approval decisions from the approval nodes 106a-106n. While each approval node of the approval nodes 106a-106n performs tests and decides whether the release of the derivative model 114 is approved, the release node 108 (e.g., a server) collects the approval decision (e.g., votes of whether to release or not release) in a TEE-protected process. For example, the approval decisions may be transmitted over a secure connection to the release node 108 which tallies the approval decision in a TEE of the release node 108 and determines that the derivative model 114 is to be released.

In this example, the release node 108 releases the aggregated model 114 into non-protected domain 132. Furthermore, the derivative model 114 may be propagated to the plurality of edge nodes 102.

For example, the aggregated model 114 may be provided to third-parties for use by the third-parties. Furthermore, the derivative model 114 may no longer need to be stored within hardware components such as TEEs and transmitted over secure channels. Rather, the derivative model 114 is unrestricted by any hardware elements.

Thus examples herein may ensure privacy is met based on two notions. First, any PII and models, such as the derivative model 114, that are not yet approved for release is either kept on server node 110 (e.g., an originating node), approval nodes 106 (e.g., which may be owners of the PII in some examples) and/or is always protected within TEEs 116, 118, 122, 126 of the hardware protected domain 130. Secondly, a release of the derivative model 114 may only occur after each of the approval nodes 106 has tested for privacy violations and has provided sufficient authorization. Thus, examples ensure privacy while providing a robust derivative model 114.

Some examples may use the hardware protected domain 130 for other client-side model evaluations and grants permissions to certain parties. For example, a user may obtain a model under a limited “test license” that remains in a TEE of the hardware protected domain 130, such as within approval nodes 106. The user may then test-drive the derivative model 114 before purchasing and/or implementing the derivative model 114. Only once the user fully purchases the derivative model 114, is the derivative model 114 released outside the hardware protected domain 130. PII may include any information that is personal to the plurality of users 104 and/or may be used to identify a user of the plurality of users 104. That is, PII includes information that permits the identity of an individual of the plurality of users 104 to be directly or indirectly inferred, including any information that is linked or linkable to that individual. Some examples of PII include social security number (SSN), passport number, driver's license number, taxpayer identification number, patient identification number, financial account number, credit card number, personal address information, street address, email address, medical records, personal telephone numbers, etc.

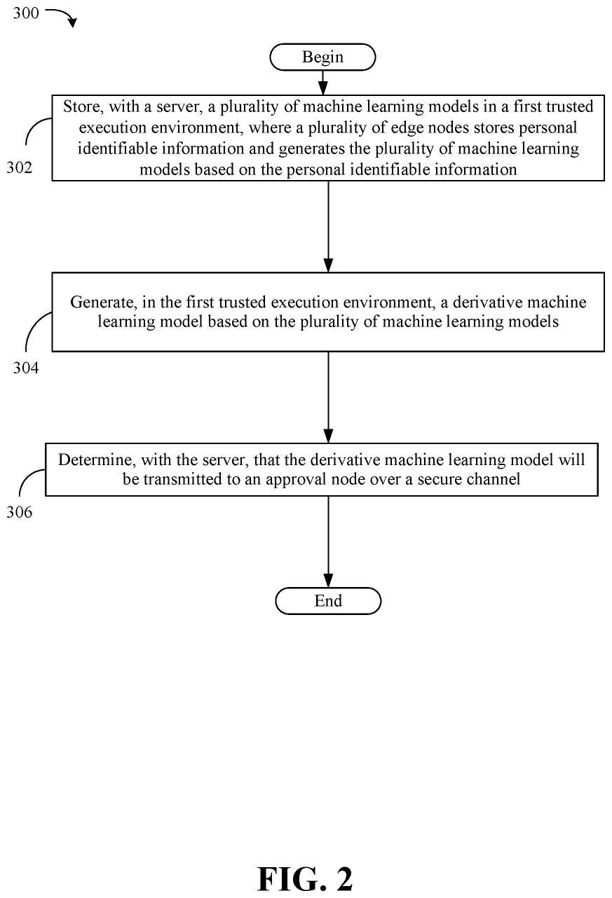

FIG. 2 shows a method 300 of a federated process of generating a ML model based on PII according to embodiments herein. The method 300 may generally be implemented with the embodiments described herein, for example, the federated ML training process 100 (FIG. 1) already discussed. More particularly, the method 300 may be implemented in one or more modules as a set of logic instructions stored in a machine- or computer-readable storage medium such as random access memory (RAM), read only memory (ROM), programmable ROM (PROM), firmware, flash memory, etc., in hardware, or any combination thereof. For example, hardware implementations may include configurable logic, fixed-functionality logic, or any combination thereof. Examples of configurable logic include suitably configured programmable logic arrays (PLAs), field programmable gate arrays (FPGAs), complex programmable logic devices (CPLDs), and general purpose microprocessors. Examples of fixed-functionality logic include suitably configured application specific integrated circuits (ASICs), general purpose microprocessor or combinational logic circuits, and sequential logic circuits or any combination thereof. The configurable or fixed-functionality logic can be implemented with complementary metal oxide semiconductor (CMOS) logic circuits, transistor-transistor logic (TTL) logic circuits, or other circuits.

For example, computer program code to carry out operations shown in the method 300 may be written in any combination of one or more programming languages, including an object-oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 302 stores, with a server, a plurality of machine learning models in a first TEE, where the plurality of machine learning models is associated with personal identifiable information. Illustrated processing block 304 generates, in the first TEE, a derivative machine learning model based on the plurality of machine learning models. Illustrated processing block 306 determines, with the server, that the derivative machine learning model will be transmitted to an approval node over a secure channel.

In some examples, the method 300 includes generating, with a plurality of edge nodes, a release policy for release of the derivative machine learning model to the approval node and the plurality of machine learning models, and determining, with the approval node, whether the derivative machine learning model complies with the release policy to determine that the derivative machine learning model is to be released. In some examples, the method 300 further includes receiving the plurality of machine learning models when an integrity of the first trusted execution environment is verified.

In some examples, the method 300 includes the approval node receiving the derivative machine learning model, storing the derivative machine learning model in a second trusted execution environment of a second processor of the approval node, executing a plurality of privacy approval tests to verify that the personally identifiable information cannot be derived from the derivative machine learning model, generating approval decisions based on the execution of the plurality of privacy approval tests, and transmitting the approval decisions to a release node. In such examples, the method 300 includes determining whether the approval decisions meet one or more of a pre-determined condition or a predetermined policy, and determining whether to release the derivative machine learning model based on whether the approval decisions meet the one or more of the pre-determined condition or the predetermined policy. In such examples, the approval node communicates with one or more of a plurality of edge nodes to retrieve the personal identifiable information, and at least one of the plurality of privacy approval tests is to include a test that is executed based on the personal identifiable information.

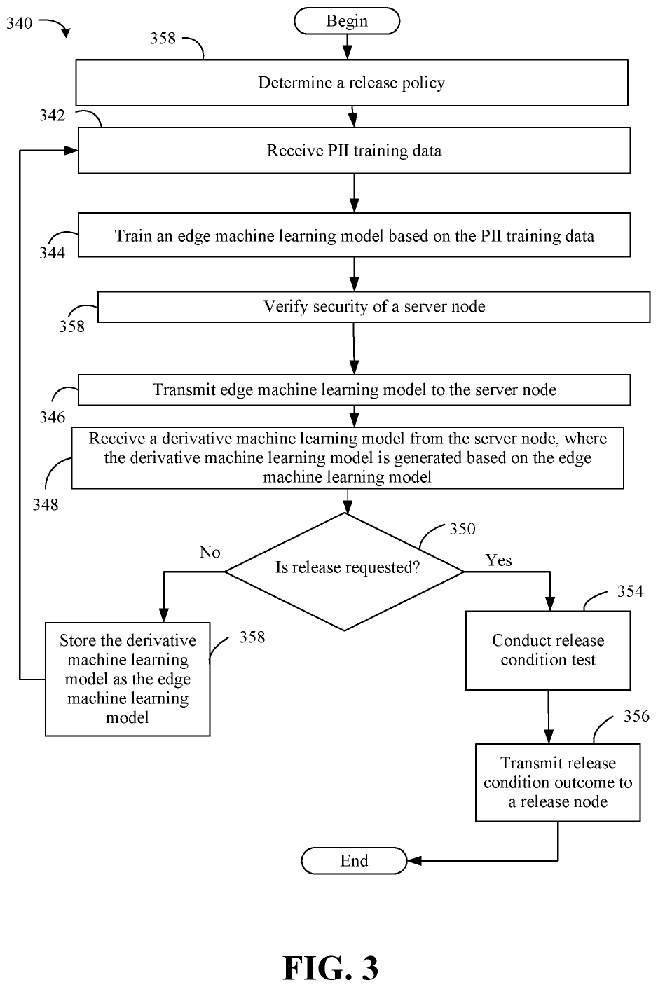

FIG. 3 shows a method 300 of generating a privacy secured ML model from the perspective of an edge node. The method 300 may be readily combinable with any of the embodiments described herein. For example, the method 300 may implement and/or operate in conjunction with one or more aspects of the federated ML training process 100 (FIG. 1) and/or method 300 (FIG. 2) already, discussed. More particularly, the method 300 may be implemented in one or more modules as a set of logic instructions stored in a machine- or computer-readable storage medium such as RAM, ROM, PROM, firmware, flash memory, etc., in configurable logic such as, for example, PLAs, FPGAs, CPLDs, in fixed-functionality hardware logic using circuit technology such as, for example, ASIC, CMOS, TTL technology, or any combination thereof.

Illustrated processing block 358 determines a release policy. For example, the release policy may pertain to releasing a derivative model (e.g., ML model) that is generated based on an edge machine learning model (discussed below). The release policy may include that the edge node must review, analyze and agree to releasing the derivative model.

Illustrated processing block 342 receives PII training data (e.g., from consumers, patients, users of the edge node). Illustrated processing block 344 trains an edge machine learning model based on the PII training data. Illustrated processing block 358 verifies security of a server node. For example, processing block 358 may require the server node attests to the security of the server node, including that the server node has a TEE that the edge machine learning model may be stored within. Illustrated processing block 346 transmit the edge machine learning model to the server node, for example based on the security of the server node being verified.

Illustrated processing block 348 receives a derivative machine learning model from the server node, where the derivative machine learning model is generated based on the edge machine learning model. For example, the server node may aggregate edge machine learning models from a plurality of edge nodes to generate the derivative machine learning model.

Illustrated processing block 350 determines if a release is requested. That is, the server node may request authorization to release the derivate model to the public and/or other approval node(s). If so, illustrated processing block 354 conducts a release condition test (e.g., based on PII data) on the derivative machine learning model and according to release policy. Illustrated processing block 356 transmits a release condition outcome to a release node. For example, if the release condition test indicates that the PII training data is unlikely to be determined from the derivative ML model, the release condition may indicate that the derivative ML model may be released. If the release condition test indicates that the PII training data is likely to be determined from the derivative ML model, the release condition may indicate that the derivative ML model may not be released.

If processing block 350 determines that no release is requested, illustrated processing block 358 stores the derivative model as the edge machine learning model and processing block 342 executes. The edge machine learning model (e.g., the derivative model) is then trained on PII data. Thus, the derivative model may be iteratively propagated to edge nodes and updated by the edge nodes to achieve a refined and robust derivative model.

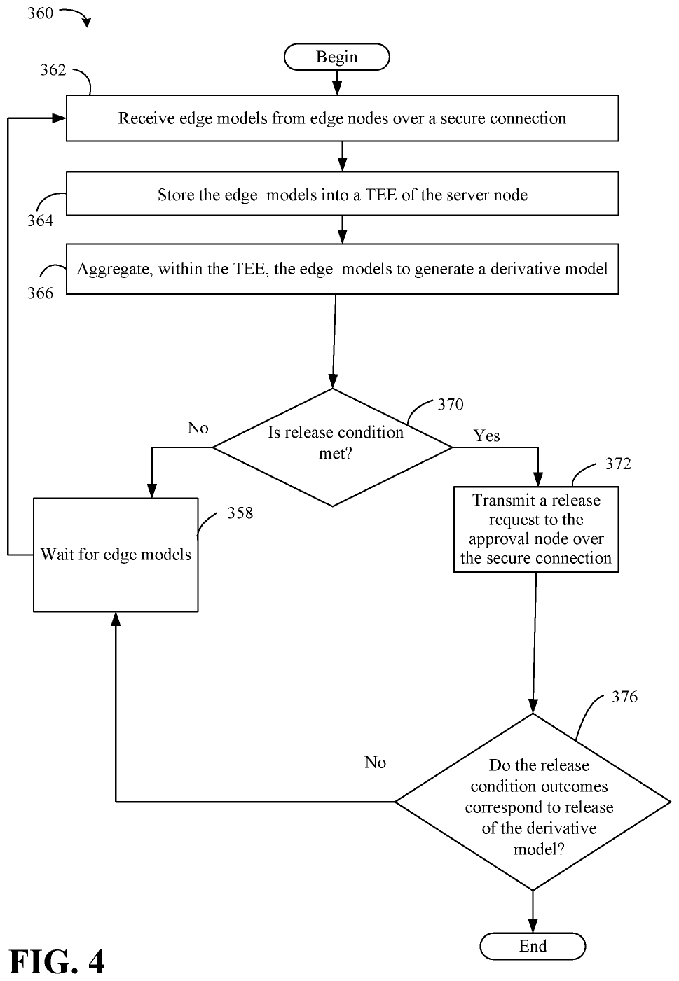

FIG. 4 shows a method 360 of generating a derivative machine learning model from the perspective of a server node. The method 360 may be readily combinable with any of the embodiments described herein. For example, the method 360 may implement and/or operate in conjunction with one or more aspects of the federated ML training process 100 (FIG. 1), method 300 (FIG. 2) and/or method 340 (FIG. 3) already discussed. More particularly, the method 360 may be implemented in one or more modules as a set of logic instructions stored in a machine- or computer-readable storage medium such as RAM, ROM, PROM, firmware, flash memory, etc., in configurable logic such as, for example, PLAs, FPGAs, CPLDs, in fixed-functionality hardware logic using circuit technology such as, for example, ASIC, CMOS, TTL technology, or any combination thereof.

Illustrated processing block 362 receives edge models from edge nodes over a secure connection. Illustrated processing block 364 stores the edge models into a TEE of the server node. Illustrated processing block 366 aggregates, within the TEE, the edge models to generate a derivative machine learning model. Illustrated processing block 370 determines if a release condition is met. For example, the release condition may be that all of the edge nodes have provided machine learning models. In some examples, the release condition may be that the edge nodes have provided several iterations of updated edge ML models.

If the release condition is not met illustrated processing block 358 waits for edge models and processing block 362 executes. If processing block 370 determines that the release condition is met, illustrated processing block 372 transmits a release request to the approval node over the secure connection.

Illustrated processing block 376 determines if the release condition outcomes corresponds to release of the derivative model. If so, no further updates to the derivative model are needed at this time and the method 360 ends. Otherwise, processing block 358 executes.

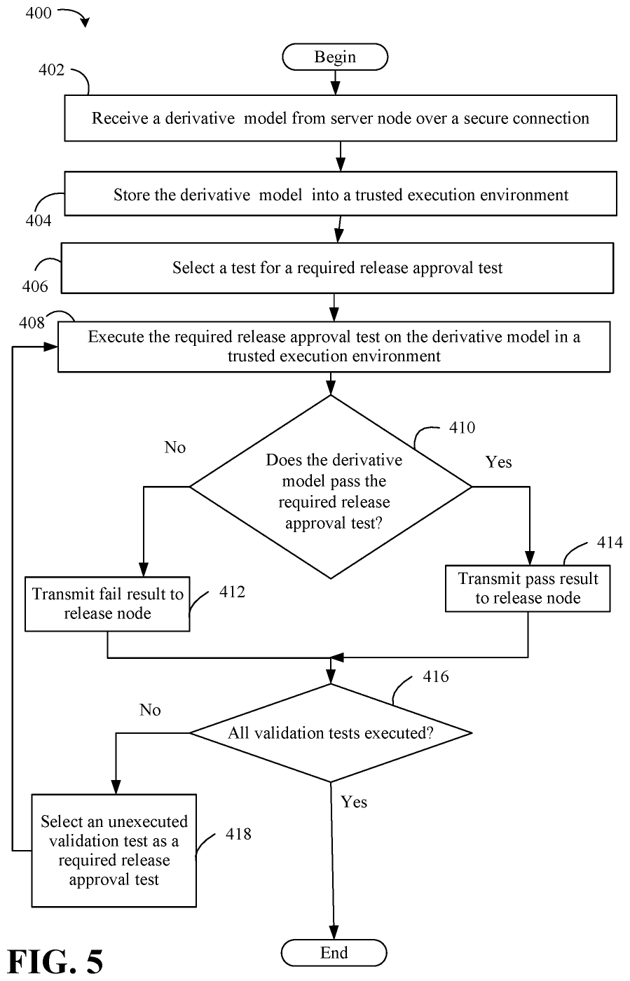

FIG. 5 shows a method 400 of determining whether to approve a derivative machine learning model from the perspective of an approval node. The method 400 may be readily combinable with any of the embodiments described herein. For example, the method 400 may implement and/or operate in conjunction with one or more aspects of the federated ML training process 100 (FIG. 1), method 300 (FIG. 2), method 340 (FIG. 3), and/or method 360 (FIG. 4) already discussed. More particularly, the method 400 may be implemented in one or more modules as a set of logic instructions stored in a machine- or computer-readable storage medium such as RAM, ROM, PROM, firmware, flash memory, etc., in configurable logic such as, for example, PLAs, FPGAs, CPLDs, in fixed-functionality hardware logic using circuit technology such as, for example, ASIC, CMOS, TTL technology, or any combination thereof.

Illustrated processing block 402 receives a derivative model from a server node over a secure connection. Illustrated processing block 404 stores the derivative model into a TEE of the approval node (e.g., in a TEE of a processor of the approval node). Illustrated processing block 406 selects a test (e.g., a membership inference test, a model inversion test, a complex tests for privacy audits such as the ML Privacy Meter, etc.) for a required release approval test. Illustrated processing block 408 executes the required release approval test on the derivative machine learning model in a TEE. Illustrated processing block 410 determines if the derivative model passes the required release approval test. If so, illustrated processing block 414 transmits a pass result to a release node. Otherwise, illustrated processing block 412 transmits a fail result to the release node.

Illustrated processing block 416 determines if all validation tests are executed. If so, the method 400 ends. Otherwise, illustrated processing block 418 selects an unexecuted validation test as a required release approval test and processing block 408 executes.

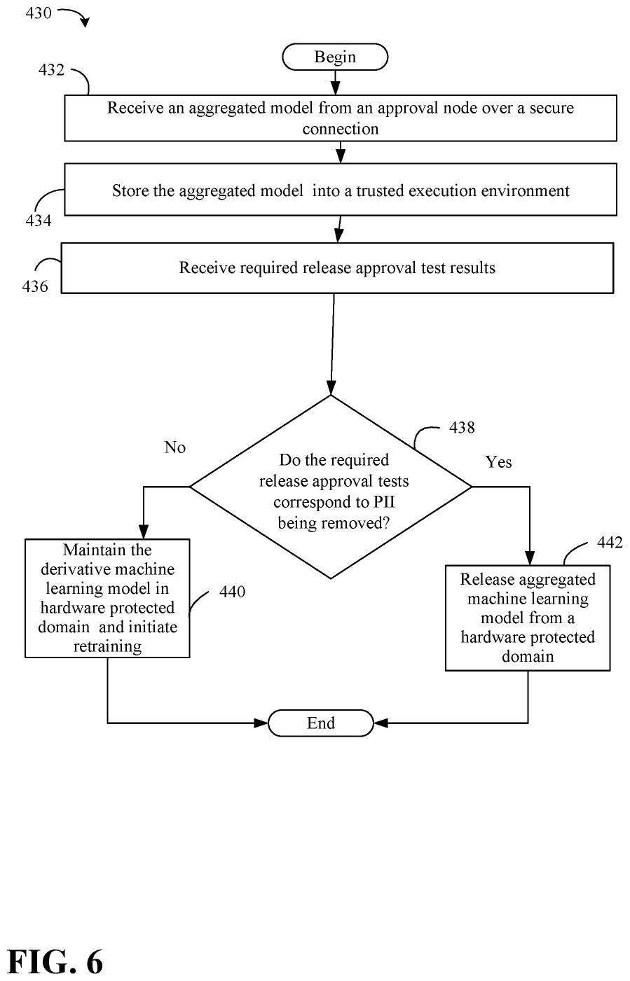

FIG. 6 shows a method 430 of determining whether to approve a derivative machine learning model from the perspective of a release node. The method 430 may be readily combinable with any of the embodiments described herein. For example, the, the federated ML training process 100 (FIG. 1), method 300 (FIG. 2), method 340 (FIG. 3), method 360 (FIG. 4) and/or method 400 (FIG. 5), already discussed. More particularly, the method 430 may be implemented in one or more modules as a set of logic instructions stored in a machine- or computer-readable storage medium such as RAM, ROM, PROM, firmware, flash memory, etc., in configurable logic such as, for example, PLAs, FPGAs, CPLDs, in fixed-functionality hardware logic using circuit technology such as, for example, ASIC, CMOS, TTL technology, or any combination thereof.

Illustrated processing block 432 receives an aggregated model from an approval node over a secure connection. Illustrated processing block 434 stores the aggregated model into a TEE. Illustrated processing block 436 receives the required release approval test results. For example, processing block 436 may receive the required release approval test results (e.g., pass results and/or fail results, approval decisions, etc.) from approval nodes. Illustrated processing block 438 determines if the required release approval tests correspond to PII being removed. For example, if the required release approval test results are pass results, the PII may be considered to be removed. In some examples, the required release approval test results may be considered votes that either indicate that the derivative ML model is secure and that PII cannot be derived from the derivative ML model (e.g., corresponds to pass results), or votes that the derivative ML model is not secure and the PII can be derived from the derivative ML model (e.g., corresponds to fail result).

If processing block 438 determines that the required release approval tests correspond to the PII being removed, illustrated processing block 442 may release the aggregated machine learning model from the hardware protected domain. Otherwise, illustrated processing block 440 maintains the derivative ML model in the hardware protected domain and initiates retraining. For example, the edge nodes may retrain the derivative machine learning model to anonymize PII and generate updated derivative machine learning models. The server node may receive the updated derivative ML models and generate a new ML model based on the updated derivative ML models.

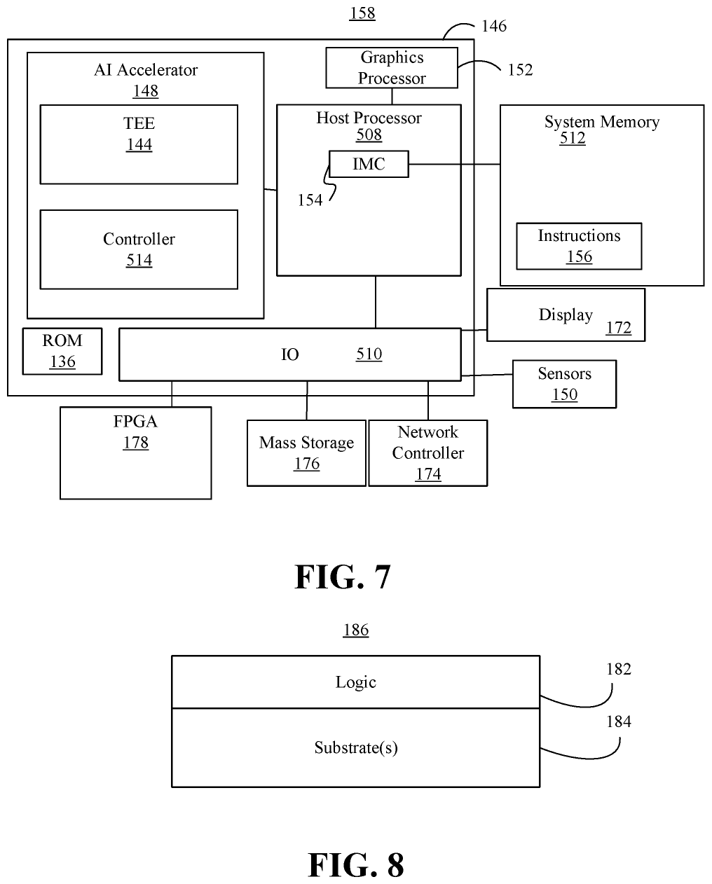

Turning now to FIG. 7, a distributed-privacy ML model generation computing system 158 is shown. The distributed-privacy ML model generation computing system 158 may generally be part of an electronic device/platform having computing functionality (e.g., personal digital assistant/PDA, notebook computer, tablet computer, convertible tablet, server), communications functionality (e.g., smart phone), imaging functionality (e.g., camera, camcorder), media playing functionality (e.g., smart television/TV), wearable functionality (e.g., watch, eyewear, headwear, footwear, jewelry), vehicular functionality (e.g., car, truck, motorcycle), robotic functionality (e.g., autonomous robot, manufacturing robot, autonomous vehicle, industrial robot, etc.), edge device (e.g., mobile phone, desktop, etc.), hospital setting, etc., or any combination thereof. In the illustrated example, the distributed-privacy ML model generation computing system 158 includes a host processor 508 (e.g., CPU) having an integrated memory controller (IMC) 154 that is coupled to a system memory 512.

The illustrated computing system 158 also includes an input output (IO) module 510 implemented together with the host processor 508, the graphics processor 152 (e.g., GPU), ROM 136, and AI accelerator 148 on a semiconductor die 146 as a system on chip (SoC). The illustrated IO module 510 communicates with, for example, a display 172 (e.g., touch screen, liquid crystal display/LCD, light emitting diode/LED display), a network controller 174 (e.g., wired and/or wireless), FPGA 178 and mass storage 176 (e.g., hard disk drive/HDD, optical disk, solid state drive/SSD, flash memory). The IO module 510 also communicates with sensors 150 (e.g., video sensors, audio sensors, proximity sensors, heat sensors, etc.).

The SoC 146 may further include processors (not shown) and/or the AI accelerator 148 dedicated to AI and/or neural network (NN) processing. For example, the system SoC 146 may include vision processing units (VPUs,) and/or other AI/NN-specific processors such as the AI accelerator 148, etc. In some embodiments, any aspect of the embodiments described herein may be implemented in the processors, such as the graphics processor 152 and/or the host processor 508, and in the accelerators dedicated to AI and/or NN processing such as AI accelerator 148 or other devices such as the FPGA 178.

The graphics processor 152, AI accelerator 148 and/or the host processor 508 may execute instructions 156 retrieved from the system memory 512 (e.g., a dynamic random-access memory) and/or the mass storage 176 to implement aspects as described herein. For example, the network controller 174 may be in communication with a plurality of edge nodes implemented in one or more of configurable logic or fixed-functionality logic. The edge nodes may store PII and generate ML models based on the PII. The network controller 174 receives the plurality of ML models. The AI accelerator (e.g., a processor) includes the TEE 144. The AI accelerator 148 includes a controller 514 implemented in one or more of configurable logic or fixed-functionality logic. The controller 514 stores the ML models in the TEE 144, generates, in the TEE, a derivative ML model based on the ML models, and causes the derivative ML model to be transmitted to an approval node through the network controller 174 and over a secure channel. It is to be understood that any other node as described herein (e.g., edge node, approval node, release node, etc.) may adopt a similar architecture to the distributed-privacy ML model generation computing system 158.

In some examples, when the instructions 156 are executed, the computing system 158 may implement one or more aspects of the embodiments described herein. For example, the computing system 158 may implement one or more aspects of the embodiments described herein, for example, the federated ML training process 100 (FIG. 1), method 300 (FIG. 2), method 340 (FIG. 3), method 360 (FIG. 4), method 400 (FIG. 5) and/or method 400 (FIG. 6) already discussed. The illustrated computing system 158 is therefore considered to be security-enhanced at least to the extent that the computing system 158 may enable a ML model to train on PII while reducing the probability that the PII may be derived from the ML model.

FIG. 8 shows a semiconductor apparatus 186 (e.g., chip, die, package). The illustrated apparatus 186 includes one or more substrates 184 (e.g., silicon, sapphire, gallium arsenide) and logic 182 (e.g., transistor array and other integrated circuit/IC components) coupled to the substrate(s) 184. In an embodiment, the apparatus 186 is operated in an application development stage and the logic 182 performs one or more aspects of the embodiments described herein. For example, the apparatus 186 may generally implement the embodiments described herein, for example the federated ML training process 100 (FIG. 1), method 300 (FIG. 2), method 340 (FIG. 3), method 360 (FIG. 4), method 400 (FIG. 5) and/or method 400 (FIG. 6) already discussed. The logic 182 may be implemented at least partly in configurable logic or fixed-functionality hardware logic. In one example, the logic 182 includes transistor channel regions that are positioned (e.g., embedded) within the substrate(s) 184. Thus, the interface between the logic 182 and the substrate(s) 184 may not be an abrupt junction. The logic 182 may also be considered to include an epitaxial layer that is grown on an initial wafer of the substrate(s) 184.

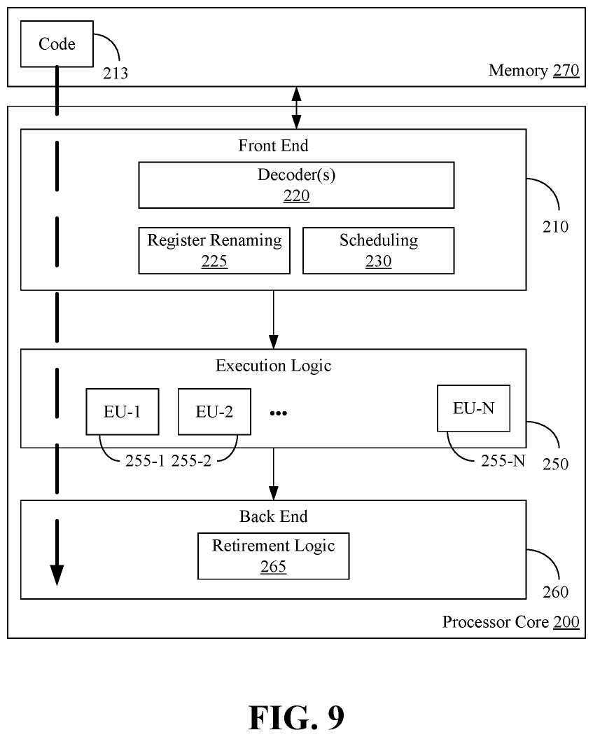

FIG. 9 illustrates a processor core 200 according to one embodiment. The processor core 200 may be the core for any type of processor, such as a micro-processor, an embedded processor, a digital signal processor (DSP), a network processor, or other device to execute code. Although only one processor core 200 is illustrated in FIG. 9, a processing element may alternatively include more than one of the processor core 200 illustrated in FIG. 9. The processor core 200 may be a single-threaded core or, for at least one embodiment, the processor core 200 may be multithreaded in that it may include more than one hardware thread context (or “logical processor”) per core.

FIG. 9 also illustrates a memory 270 coupled to the processor core 200. The memory 270 may be any of a wide variety of memories (including various layers of memory hierarchy) as are known or otherwise available to those of skill in the art. The memory 270 may include one or more code 213 instruction(s) to be executed by the processor core 200, wherein the code 213 may implement one or more aspects of the embodiments such as, for example, the federated ML training process 100 (FIG. 1), method 300 (FIG. 2), method 340 (FIG. 3), method 360 (FIG. 4), method 400 (FIG. 5) and/or method 400 (FIG. 6) already discussed. The processor core 200 follows a program sequence of instructions indicated by the code 213. Each instruction may enter a front end portion 210 and be processed by one or more decoders 220. The decoder 220 may generate as its output a micro operation such as a fixed width micro operation in a predefined format, or may generate other instructions, microinstructions, or control signals which reflect the original code instruction. The illustrated front end portion 210 also includes register renaming logic 225 and scheduling logic 230, which generally allocate resources and queue the operation corresponding to the convert instruction for execution.

The processor core 200 is shown including execution logic 250 having a set of execution units 255-1 through 255-N. Some embodiments may include several execution units dedicated to specific functions or sets of functions. Other embodiments may include only one execution unit or one execution unit that can perform a particular function. The illustrated execution logic 250 performs the operations specified by code instructions.

After completion of execution of the operations specified by the code instructions, retirement logic 265 of the back-end 260 retires the instructions of the code 213. In one embodiment, the processor core 200 allows out of order execution but requires in order retirement of instructions. Retirement logic 265 may take a variety of forms as known to those of skill in the art (e.g., re-order buffers or the like). In this manner, the processor core 200 is transformed during execution of the code 213, at least in terms of the output generated by the decoder, the hardware registers and tables utilized by the register renaming logic 225, and any registers (not shown) modified by the execution logic 250.

Although not illustrated in FIG. 9, a processing element may include other elements on chip with the processor core 200. For example, a processing element may include memory control logic along with the processor core 200. The processing element may include I/O control logic and/or may include I/O control logic integrated with memory control logic. The processing element may also include one or more caches.

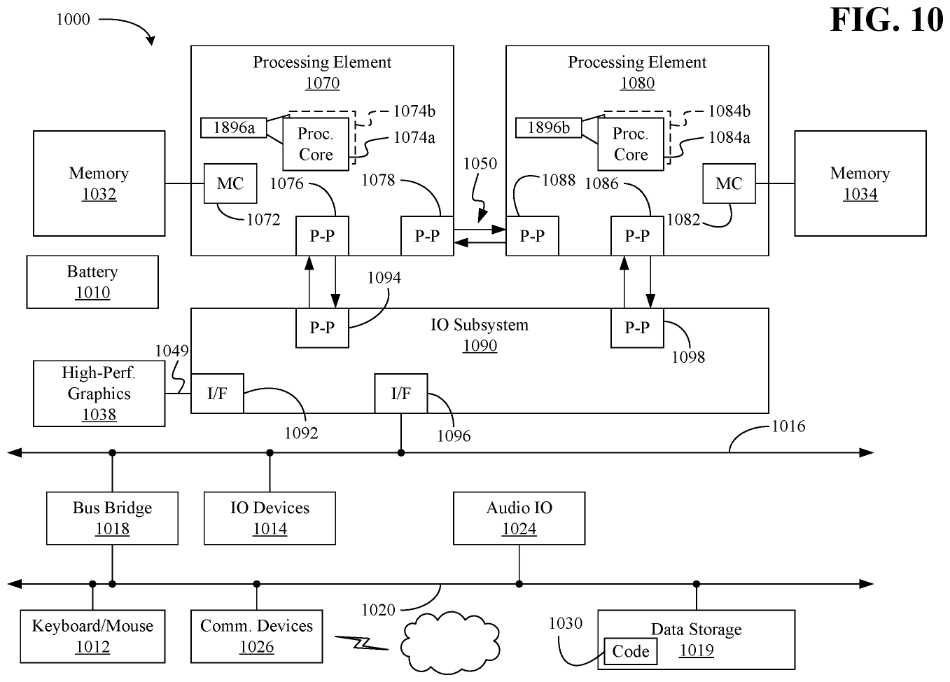

Referring now to FIG. 10, shown is a block diagram of a computing system 1000 embodiment in accordance with an embodiment. Shown in FIG. 10 is a multiprocessor system 1000 that includes a first processing element 1070 and a second processing element 1080. While two processing elements 1070 and 1080 are shown, it is to be understood that an embodiment of the system 1000 may also include only one such processing element.

The system 1000 is illustrated as a point-to-point interconnect system, wherein the first processing element 1070 and the second processing element 1080 are coupled via a point-to-point interconnect 1050. It should be understood any or all the interconnects illustrated in FIG. 10 may be implemented as a multi-drop bus rather than point-to-point interconnect.

As shown in FIG. 10, each of processing elements 1070 and 1080 may be multicore processors, including first and second processor cores (i.e., processor cores 1074a and 1074b and processor cores 1084a and 1084b). Such cores 1074a, 1074b, 1084a, 1084b may be configured to execute instruction code in a manner like that discussed above in connection with FIG. 9.

Each processing element 1070, 1080 may include at least one shared cache 1896a, 1896b. The shared cache 1896a, 1896b may store data (e.g., instructions) that are utilized by one or more components of the processor, such as the cores 1074a, 1074b and 1084a, 1084b, respectively. For example, the shared cache 1896a, 1896b may locally cache data stored in a memory 1032, 1034 for faster access by components of the processor. In one or more embodiments, the shared cache 1896a, 1896b may include one or more mid-level caches, such as level 2 (L2), level 3 (L3), level 4 (L4), or other levels of cache, a last level cache (LLC), and/or combinations thereof.

While shown with only two processing elements 1070, 1080, it is to be understood that the scope of the embodiments is not so limited. In other embodiments, one or more additional processing elements may be present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There can be a variety of differences between the processing elements 1070, 1080 in terms of a spectrum of metrics of merit including architectural, micro architectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

The first processing element 1070 may further include memory controller logic (MC) 1072 and point-to-point (P-P) interfaces 1076 and 1078. Similarly, the second processing element 1080 may include a MC 1082 and P-P interfaces 1086 and 1088. As shown in FIG. 10, MC's 1072 and 1082 couple the processors to respective memories, namely a memory 1032 and a memory 1034, which may be portions of main memory locally attached to the respective processors. While the MC 1072 and 1082 is illustrated as integrated into the processing elements 1070, 1080, for alternative embodiments the MC logic may be discrete logic outside the processing elements 1070, 1080 rather than integrated therein.

The first processing element 1070 and the second processing element 1080 may be coupled to an I/O subsystem 1090 via P-P interconnects 1076 1086, respectively. As shown in FIG. 10, the I/O subsystem 1090 includes P-P interfaces 1094 and 1098. Furthermore, I/O subsystem 1090 includes an interface 1092 to couple I/O subsystem 1090 with a high performance graphics engine 1038. In one embodiment, bus 1049 may be used to couple the graphics engine 1038 to the I/O subsystem 1090. Alternately, a point-to-point interconnect may couple these components.

In turn, I/O subsystem 1090 may be coupled to a first bus 1016 via an interface 1096. In one embodiment, the first bus 1016 may be a Peripheral Component Interconnect (PCI) bus, or a bus such as a PCI Express bus or another third generation I/O interconnect bus, although the scope of the embodiments is not so limited.

As shown in FIG. 10, various I/O devices 1014 (e.g., biometric scanners, speakers, cameras, sensors) may be coupled to the first bus 1016, along with a bus bridge 1018 which may couple the first bus 1016 to a second bus 1020. In one embodiment, the second bus 1020 may be a low pin count (LPC) bus. Various devices may be coupled to the second bus 1020 including, for example, a keyboard/mouse 1012, communication device(s) 1026, and a data storage unit 1019 such as a disk drive or other mass storage device which may include code 1030, in one embodiment. The illustrated code 1030 may implement the one or more aspects of such as, for example, the the federated ML training process 100 (FIG. 1), method 300 (FIG. 2), method 340 (FIG. 3), method 360 (FIG. 4), method 400 (FIG. 5) and/or method 400 (FIG. 6) already discussed. Further, an audio I/O 1024 may be coupled to second bus 1020 and a battery 1010 may supply power to the computing system 1000.

Note that other embodiments are contemplated. For example, instead of the point-to-point architecture of FIG. 10, a system may implement a multi-drop bus or another such communication topology. Also, the elements of FIG. 10 may alternatively be partitioned using more or fewer integrated chips than shown in FIG. 10.

### Additional Notes and Examples

Example 1 includes a computing system comprising a network controller to receive a plurality of machine learning models, wherein the plurality of machine learning models is associated with personal identifiable information, a first processor that includes a first trusted execution environment, a controller implemented in one or more of configurable logic or fixed-functionality logic, wherein the controller is to store a plurality of machine learning models in the first trusted execution environment, generate a derivative machine learning model based on the plurality of machine learning models, and determine that the derivative machine learning model is to be transmitted to an approval node over a secure channel.

Example 2 includes the computing system of Example 1, where a plurality of edge nodes generates a release policy for the derivative machine learning model to be released, and the plurality of edge nodes further generates the plurality of machine learning models, and the approval node is to determine whether the derivative machine learning model complies with the release policy to determine whether the derivative machine learning model is to be released.

Example 3 includes the computing system of any one of Examples 1 to 2, wherein the network controller is to receive the plurality of machine learning models when an integrity of the first trusted execution environment is verified.

Example 4 includes the computing system of any one of Examples 1 to 3, wherein the approval node is to receive the derivative machine learning model from the network controller, store the derivative machine learning model in a second trusted execution environment of a second processor of the approval node, execute a plurality of privacy approval tests to verify that the personally identifiable information cannot be derived from the derivative machine learning model, generate approval decisions based on the execution of the plurality of privacy approval tests, and transmit the approval decisions to a release node.

Example 5 includes the computing system of Example 4, wherein the release node is to determine whether the approval decisions meet one or more of a pre-determined condition or a predetermined policy, and determine whether to release the derivative machine learning model based on whether the approval decisions meet the one or more of the pre-determined condition or the predetermined policy.

Example 6 includes the computing system of Example 4, wherein the approval node communicates with one or more of a plurality of edge nodes to retrieve the personal identifiable information, and at least one of the plurality of privacy approval tests is to include a test that is executed based on the personal identifiable information.

Example 7 includes a semiconductor apparatus, the semiconductor apparatus comprising one or more substrates, and logic coupled to the one or more substrates, wherein the logic is implemented in one or more of configurable logic or fixed-functionality logic, the logic coupled to the one or more substrates to store, with a server, a plurality of machine learning models in a first trusted execution environment, wherein the plurality of machine learning models is associated with personal identifiable information, generate, in the first trusted execution environment, a derivative machine learning model based on the plurality of machine learning models, and determine, with the server, that the derivative machine learning model is to be transmitted to an approval node over a secure channel.

Example 8 includes the apparatus of Example 7, wherein the logic coupled to the one or more substrates is to generate, with a plurality of edge nodes, a release policy for the derivative machine learning model to be released, generate, with the plurality of edge nodes, the plurality of machine learning models and determine, with the approval node, whether the derivative machine learning model complies with the release policy to determine that the derivative machine learning model is to be released and the plurality of machine learning models.

Example 9 includes the apparatus of any one of Examples 7 to 8, wherein the logic coupled to the one or more substrates is to receive the plurality of machine learning models when an integrity of the first trusted execution environment is verified.

Example 10 includes the apparatus of any one of Examples 7 to 9, wherein the logic coupled to the one or more substrates is to receive, with the approval node, the derivative machine learning model from the server, store, with the approval node, the derivative machine learning model in a second trusted execution environment of a second processor of the approval node, execute, with the approval node, a plurality of privacy approval tests to verify that the personally identifiable information cannot be derived from the derivative machine learning model, generate, with the approval node, approval decisions based on the execution of the plurality of privacy approval tests, and transmit, with the approval node, the approval decisions to a release node.

Example 11 includes the apparatus of Example 10, wherein the logic coupled to the one or more substrates is to determine, with the release node, whether the approval decisions meet one or more of a pre-determined condition or a predetermined policy, and determine, with the release node, whether to release the derivative machine learning model based on whether the approval decisions meet the one or more of the pre-determined condition or the predetermined policy.

Example 12 includes the apparatus of Example 10, wherein the approval node communicates with one or more of a plurality of edge nodes to retrieve the personal identifiable information, and at least one of the plurality of privacy approval tests is to include a test that is executed based on the personal identifiable information.

Example 13 includes the apparatus of Example 7, wherein the logic coupled to the one or more substrates includes transistor channel regions that are positioned within the one or more substrates.

Example 14 includes at least one computer readable storage medium comprising a set of executable program instructions, which when executed by a computing system, cause the computing system to store, with a server, a plurality of machine learning models in a first trusted execution environment, wherein the plurality of machine learning models is associated with personal identifiable information, generate, in the first trusted execution environment, a derivative machine learning model based on the plurality of machine learning models, and determine, with the server, that the derivative machine learning model is to be transmitted to an approval node over a secure channel.

Example 15 includes the at least one computer readable storage medium of Example 14, wherein the instructions, when executed, further cause the computing system to generate, with a plurality of edge nodes, a release policy for the derivative machine learning model to be released to the approval node, generate, with the plurality of edge nodes, the plurality of machine learning models, and determine, with the approval node, whether the derivative machine learning model complies with the release policy to determine that the derivative machine learning model is to be released.

Example 16 includes the at least one computer readable storage medium of any one of Examples 14 to 15, wherein the instructions, when executed, further cause the computing system to receive the plurality of machine learning models when an integrity of the first trusted execution environment is verified.

Example 17 includes the at least one computer readable storage medium of any one of Examples 14 to 16, wherein the instructions, when executed, further cause the computing system to receive, with the approval node, the derivative machine learning model from the server, store, with the approval node, the derivative machine learning model in a second trusted execution environment of a second processor of the approval node, execute, with the approval node, a plurality of privacy approval tests to verify that the personally identifiable information cannot be derived from the derivative machine learning model, generate, with the approval node, approval decisions based on the execution of the plurality of privacy approval tests, and transmit, with the approval node, the approval decisions to a release node.

Example 18 includes the at least one computer readable storage medium of Example 17, wherein the instructions, when executed, further cause the computing system to determine, with the release node, whether the approval decisions meet one or more of a pre-determined condition or a predetermined policy, and determine, with the release node, whether to release the derivative machine learning model based on whether the approval decisions meet the one or more of the pre-determined condition or the predetermined policy.

Example 19 includes the at least one computer readable storage medium of Example 17, wherein the approval node communicates with one or more of the plurality of edge nodes to retrieve the personal identifiable information, and at least one of the plurality of privacy approval tests is to include a test that is executed based on the personal identifiable information.

Example 20 includes a method comprising storing, with a server, a plurality of machine learning models in a first trusted execution environment, wherein the plurality of machine learning models is associated with personal identifiable information, generating, in the first trusted execution environment, a derivative machine learning model based on the plurality of machine learning models, and determining, with the server, that the derivative machine learning model will be transmitted to an approval node over a secure channel.

Example 21 includes the method of Example 20, further comprising generating, with a plurality of edge nodes, a release policy for release of the derivative machine learning model to the approval node, generating, with the plurality of edge nodes, the plurality of machine learning models, and determining, with the approval node, whether the derivative machine learning model complies with the release policy to determine that the derivative machine learning model is to be released.

Example 22 includes the method of any one of Examples 20 to 21, further comprising receiving the plurality of machine learning models when an integrity of the first trusted execution environment is verified.

Example 23 includes the method of any one of Examples 20 to 22, further comprising receiving, with the approval node, the derivative machine learning model from the server, storing, with the approval node, the derivative machine learning model in a second trusted execution environment of a second processor of the approval node, executing, with the approval node, a plurality of privacy approval tests to verify that the personally identifiable information cannot be derived from the derivative machine learning model, generating, with the approval node, approval decisions based on the execution of the plurality of privacy approval tests, and transmitting, with the approval node, the approval decisions to a release node.

Example 24 includes the method of Example 23, further comprising determining, with the release node, whether the approval decisions meet one or more of a pre-determined condition or a predetermined policy, and determining, with the release node, whether to release the derivative machine learning model based on whether the approval decisions meet the one or more of the pre-determined condition or the predetermined policy.

Example 25 includes the method of Example 23, wherein the approval node communicates with one or more of a plurality of edge nodes to retrieve the personal identifiable information, and at least one of the plurality of privacy approval tests is to include a test that is executed based on the personal identifiable information.

Example 26 includes a semiconductor apparatus comprising means for storing, with a server, a plurality of machine learning models in a first trusted execution environment, wherein the plurality of machine learning models is associated with personal identifiable information, means for generating, in the first trusted execution environment, a derivative machine learning model based on the plurality of machine learning models, and means for determining, with the server, that the derivative machine learning model will be transmitted to an approval node over a secure channel.

Example 27 includes the apparatus of Example 26, further comprising means for generating, with a plurality of edge nodes, a release policy for release of the derivative machine learning model to the approval node, means for generating, with the plurality of edge nodes, the plurality of machine learning models, means for determining, with the approval node, whether the derivative machine learning model complies with the release policy to determine that the derivative machine learning model is to be released.

Example 28 includes the apparatus of any one of Example 26 to 27, further comprising means for receiving the plurality of machine learning models when an integrity of the first trusted execution environment is verified.

Example 29 includes the apparatus of any one of Examples 26 to 28, further comprising means for receiving, with the approval node, the derivative machine learning model from the server, means for storing, with the approval node, the derivative machine learning model in a second trusted execution environment of a second processor of the approval node, means for executing, with the approval node, a plurality of privacy approval tests to verify that the personally identifiable information cannot be derived from the derivative machine learning model, means for generating, with the approval node, approval decisions based on the execution of the plurality of privacy approval tests, and means for transmitting, with the approval node, the approval decisions to a release node.

Example 30 includes the apparatus of Example 29, further comprising means for determining, with the release node, whether the approval decisions meet one or more of a pre-determined condition or a predetermined policy, and means for determining, with the release node, whether to release the derivative machine learning model based on whether the approval decisions meet the one or more of the pre-determined condition or the predetermined policy.

Example 31 includes the apparatus of Example 29, wherein the approval node communicates with one or more of a plurality of edge nodes to retrieve the personal identifiable information, and at least one of the plurality of privacy approval tests is to include a test that is executed based on the personal identifiable information.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical, or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A, B, C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A computing system comprising:
a network controller to receive a plurality of machine learning models, wherein the plurality of machine learning models is associated with personal identifiable information;
a first processor that includes a first trusted execution environment;
a controller implemented in one or more of configurable logic or fixed-functionality logic, wherein the controller is to:
store the plurality of machine learning models in the first trusted execution environment;
generate a derivative machine learning model based on the plurality of machine learning models; and
determine that the derivative machine learning model is to be transmitted to an approval node over a secure channel.

2. The computing system of claim 1, wherein:
a plurality of edge nodes generates a release policy for the derivative machine learning model to be released, and the plurality of edge nodes further generates the plurality of machine learning models; and
the approval node is to determine whether the derivative machine learning model complies with the release policy to determine whether the derivative machine learning model is to be released.

3. The computing system of claim 1, wherein the network controller is to receive the plurality of machine learning models when an integrity of the first trusted execution environment is verified.

4. The computing system of claim 1, wherein the approval node is to:
receive the derivative machine learning model from the network controller;
store the derivative machine learning model in a second trusted execution environment of a second processor of the approval node;
execute a plurality of privacy approval tests to verify that the personally identifiable information cannot be derived from the derivative machine learning model;
generate approval decisions based on the execution of the plurality of privacy approval tests; and
transmit the approval decisions to a release node.

5. The computing system of claim 4, wherein the release node is to:
determine whether the approval decisions meet one or more of a pre-determined condition or a predetermined policy; and
determine whether to release the derivative machine learning model based on whether the approval decisions meet the one or more of the pre-determined condition or the predetermined policy.

6. The computing system of claim 4, wherein:
the approval node communicates with one or more of a plurality of edge nodes to retrieve the personal identifiable information; and
at least one of the plurality of privacy approval tests is to include a test that is executed based on the personal identifiable information.

7. A semiconductor apparatus, the semiconductor apparatus comprising:
one or more substrates; and
logic coupled to the one or more substrates, wherein the logic is implemented in one or more of configurable logic or fixed-functionality logic, the logic coupled to the one or more substrates to:
store, with a server, a plurality of machine learning models in a first trusted execution environment, wherein the plurality of machine learning models is associated with personal identifiable information;
generate, in the first trusted execution environment, a derivative machine learning model based on the plurality of machine learning models; and
determine, with the server, that the derivative machine learning model is to be transmitted to an approval node over a secure channel.

8. The apparatus of claim 7, wherein the logic coupled to the one or more substrates is to:
generate, with a plurality of edge nodes, a release policy for the derivative machine learning model to be released;
generate, with the plurality of edge nodes, the plurality of machine learning models; and
determine, with the approval node, whether the derivative machine learning model complies with the release policy to determine that the derivative machine learning model is to be released.

9. The apparatus of claim 7, wherein the logic coupled to the one or more substrates is to:
receive the plurality of machine learning models when an integrity of the first trusted execution environment is verified.

10. The apparatus of claim 7, wherein the logic coupled to the one or more substrates is to:
receive, with the approval node, the derivative machine learning model from the server;
store, with the approval node, the derivative machine learning model in a second trusted execution environment of a second processor of the approval node;
execute, with the approval node, a plurality of privacy approval tests to verify that the personally identifiable information cannot be derived from the derivative machine learning model;
generate, with the approval node, approval decisions based on the execution of the plurality of privacy approval tests; and
transmit, with the approval node, the approval decisions to a release node.

11. The apparatus of claim 10, wherein the logic coupled to the one or more substrates is to:
determine, with the release node, whether the approval decisions meet one or more of a pre-determined condition or a predetermined policy; and
determine, with the release node, whether to release the derivative machine learning model based on whether the approval decisions meet the one or more of the pre-determined condition or the predetermined policy.

12. The apparatus of claim 10, wherein:
the approval node communicates with one or more of a plurality of edge nodes to retrieve the personal identifiable information; and
at least one of the plurality of privacy approval tests is to include a test that is executed based on the personal identifiable information.

13. The apparatus of claim 7, wherein the logic coupled to the one or more substrates includes transistor channel regions that are positioned within the one or more substrates.

14. At least one computer readable storage medium comprising a set of executable program instructions, which when executed by a computing system, cause the computing system to:
store, with a server, a plurality of machine learning models in a first trusted execution environment, wherein the plurality of machine learning models is associated with personal identifiable information;
generate, in the first trusted execution environment, a derivative machine learning model based on the plurality of machine learning models; and
determine, with the server, that the derivative machine learning model is to be transmitted to an approval node over a secure channel.

15. The at least one computer readable storage medium of claim 14, wherein the instructions, when executed, further cause the computing system to:
generate, with a plurality of edge nodes, a release policy for the derivative machine learning model to be released to the approval node;
generate, with the plurality of edge nodes, the plurality of machine learning models; and
determine, with the approval node, whether the derivative machine learning model complies with the release policy to determine that the derivative machine learning model is to be released.

16. The at least one computer readable storage medium of claim 14, wherein the instructions, when executed, further cause the computing system to:
receive the plurality of machine learning models when an integrity of the first trusted execution environment is verified.

17. The at least one computer readable storage medium of claim 14, wherein the instructions, when executed, further cause the computing system to:
receive, with the approval node, the derivative machine learning model from the server;
store, with the approval node, the derivative machine learning model in a second trusted execution environment of a second processor of the approval node;
execute, with the approval node, a plurality of privacy approval tests to verify that the personally identifiable information cannot be derived from the derivative machine learning model;
generate, with the approval node, approval decisions based on the execution of the plurality of privacy approval tests; and
transmit, with the approval node, the approval decisions to a release node.

18. The at least one computer readable storage medium of claim 17, wherein the instructions, when executed, further cause the computing system to:
determine, with the release node, whether the approval decisions meet one or more of a pre-determined condition or a predetermined policy; and
determine, with the release node, whether to release the derivative machine learning model based on whether the approval decisions meet the one or more of the pre-determined condition or the predetermined policy.

19. The at least one computer readable storage medium of claim 17, wherein:
the approval node communicates with one or more of a plurality of edge nodes to retrieve the personal identifiable information; and
at least one of the plurality of privacy approval tests is to include a test that is executed based on the personal identifiable information.

20. A method comprising:
storing, with a server, a plurality of machine learning models in a first trusted execution environment, wherein the plurality of machine learning models is associated with personal identifiable information;
generating, in the first trusted execution environment, a derivative machine learning model based on the plurality of machine learning models; and
determining, with the server, that the derivative machine learning model will be transmitted to an approval node over a secure channel.

21. The method of claim 20, further comprising:
generating, with a plurality of edge nodes, a release policy for release of the derivative machine learning model to the approval node;
generating, with the plurality of edge nodes, the plurality of machine learning models; and
determining, with the approval node, whether the derivative machine learning model complies with the release policy to determine that the derivative machine learning model is to be released.

22. The method of claim 20, further comprising:
receiving the plurality of machine learning models when an integrity of the first trusted execution environment is verified.

23. The method of claim 20, further comprising:
receiving, with the approval node, the derivative machine learning model from the server;
storing, with the approval node, the derivative machine learning model in a second trusted execution environment of a second processor of the approval node;
executing, with the approval node, a plurality of privacy approval tests to verify that the personally identifiable information cannot be derived from the derivative machine learning model;
generating, with the approval node, approval decisions based on the execution of the plurality of privacy approval tests; and
transmitting, with the approval node, the approval decisions to a release node.

24. The method of claim 23, further comprising:
determining, with the release node, whether the approval decisions meet one or more of a pre-determined condition or a predetermined policy; and
determining, with the release node, whether to release the derivative machine learning model based on whether the approval decisions meet the one or more of the pre-determined condition or the predetermined policy.

25. The method of claim 23, wherein:
the approval node communicates with one or more of a plurality of edge nodes to retrieve the personal identifiable information; and
at least one of the plurality of privacy approval tests is to include a test that is executed based on the personal identifiable information.
